(19) United States
(12) Patent Application Publication
(10) Pub. No.: US 2026/0207004 A1
(43) Pub. Date: Jul. 23, 2026

(54) Cooking Press Assembly

(71) Applicant: Luis Cardenas, San Antonio, TX (US)

(72) Inventor: Luis Cardenas, San Antonio, TX (US)

(21) Appl. No.: 19/034,546

(22) Filed: Jan. 22, 2025

(51) Int. Cl. A47J 37/06

(52) U.S. Cl. CPC A47J 37/0611

(57) ABSTRACT

The present invention discloses a cooking press assembly that removably attaches to a stovetop. The cooking press assembly comprises a pressing subassembly and a screw clamp subassembly. The pressing subassembly comprises a pressing surface, a first connecting arm, and a handle. A user may apply the pressing surface to a food item by operating the handle, which is connected to the pressing surface via the first connecting arm. The screw clamp subassembly provides a mechanism by which a user may removably attach the cooking press assembly to a stovetop. The screw clamp subassembly comprises a first screw, a first clamp frame, a second screw, a second clamp frame, a clamping plate, a second connecting arm, and a pin. The pressing surface may be rapidly rotated onto the stovetop when desired, and may be rotated away from the stovetop when not in use, thereby improving over the prior art.

### BACKGROUND

Cooking presses are commonly used in food preparation to apply uniform pressure to food items, such as tortillas, sandwiches, or meats. Specifically, traditional standalone cooking presses are used to flatten or toast food, improving the overall quality, texture, and consistency of the dish. However, prior art cooking presses are not affixed to a cooking surface, making them prone to being misplaced or lost when not in use. In addition, users expend valuable time continuously moving and removing standalone cooking presses from the stovetop. The current invention addresses these shortcomings by providing a means for removably attaching a cooking press to a stovetop.

### SUMMARY

The present invention is directed to a cooking press assembly that allows a user to removably attach a cooking press to a stovetop. The assembly comprises a pressing subassembly and a screw clamp subassembly. The pressing subassembly comprises a pressing surface, a first connecting arm, and a handle. The screw clamp subassembly comprises a first screw, a first clamp frame, a second screw, a second clamp frame, a clamping plate, a second connecting arm, and a pin.

The pressing surface is a cast iron surface that is applied directly to a food item. Alternatively, the pressing surface may be composed of a metal alloy suitable for cooking applications. The pressing surface may further compromise a non-stick coating to facilitate the process of cleaning the cooking press assembly. In the preferred embodiment, the pressing surface is welded directly to the first connecting arm. The pressing surface may also be, but need not be, rotatably connected to the first connecting arm. The first connecting arm is connected to a handle for maneuvering the cooking press assembly. The handle is preferably composed of a heat-resistant material and may additionally comprise ergonomic grooves.

The pressing subassembly is connected to the screw clamp subassembly via a second connecting arm that is welded to the pressing surface. The pressing surface and the second connecting arm may be made from the same mold, forming one continuous member. The screw clamp subassembly attaches to a surface of the stovetop via the first and second screws and a clamping plate. The first screw and second screw, which are preferably swivel head screws, are threaded through a first clamp frame and a second clamp frame, respectively. The first screw and second screw are flared towards one end, providing a larger surface area by which to be fastened to a surface of the stovetop. A user may easily fasten the cooking press assembly to the surface of the stovetop by tightening the first and second screws against a surface of the stovetop.

The clamping plate is welded to or otherwise connected to both the first clamp frame and the second clamp frame. The clamping plate fastens to a surface of the stovetop opposite of the first and second clamping screws, firmly holding the cooking press assembly in place. The clamping plate further comprises knuckles for receiving a pin. The second connecting arm likewise comprises a knuckle for receiving a pin. A pin is placed through the knuckles of the clamping plate and the second connecting arm, forming a hinge. The hinge allows the user to rotate the pressing surface away from the stovetop. Thus, the pressing surface may be rapidly swung into and out of place when needed, thereby reducing overall cooking times and improving over standalone prior art cooking presses by providing users with a means to removably fasten a cooking press to a stovetop.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a perspective view of the cooking press assembly wherein the cooking press assembly is connected to a stovetop;

FIG. 2 is a perspective view of the cooking press assembly wherein the cooking press assembly is removed from a stovetop;

FIG. 3 is a perspective view of the cooking press assembly wherein the pressing subassembly is in the upright position;

FIG. 4 is a magnified perspective view of the screw clamp subassembly wherein the pressing surface is in the upright position;

FIG. 5 is a magnified perspective view of the screw clamp subassembly wherein the pressing surface is in the down position;

### DETAILED DESCRIPTION

In the Summary above and in the Detailed Description, and the claims below, and in the accompanying drawings, reference is made to particular features of the invention. It is to be understood that the disclosure of the invention in this specification includes all possible combinations of such features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Hereinafter, preferred embodiments of the present disclosure will be described in detail with reference to the accompanying drawings. Prior to the description, it should be understood that the terms or words used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the embodiments described herein and illustrations shown in the drawings are just a most preferred embodiment of the present disclosure, but not intended to fully describe the technical aspects of the present disclosure, so it should be understood that a variety of other equivalents and variations could be made thereto at the time of filing the application.

Additionally, in describing the present disclosure, when it is deemed that a detailed description of relevant known elements or functions renders the key subject matter of the present disclosure ambiguous, the detailed description is omitted herein.

The terms including the ordinal number such as “first”, “second” and the like may be used to distinguish one element from another among various elements, but not intended to limit the elements by the terms.

Unless the context clearly indicates otherwise, it will be understood that the terms “comprises” or “includes” when used in this specification, specifies the presence of stated elements, but does not preclude the presence or addition of one or more other elements. For example, an article “comprising” (or “which comprises”) components A, B, and C can consist of (i.e. contain only) components A, B, and C, or can contain not only components A, B, and C but also one or more other components. In addition, throughout the specification it will be further understood that when an element is referred to as being “connected to” another element, it can be directly connected to the other element or intervening elements that may be present.

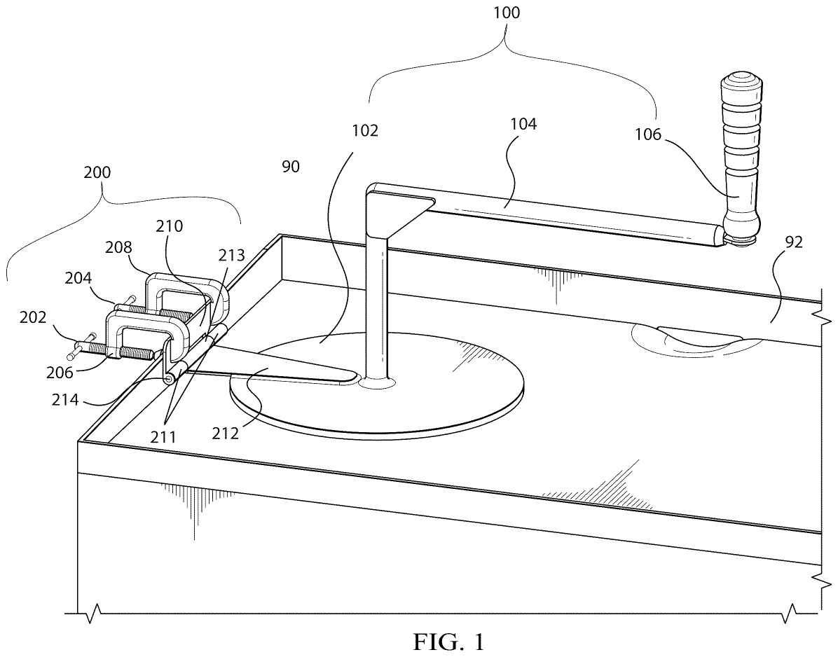

FIG. 1 depicts a perspective view of the cooking press assembly 90, wherein the cooking press assembly 90 is attached to a stove 92. The cooking press assembly 90 comprises a pressing subassembly 100 and a screw clamp subassembly 200. The pressing subassembly 100 comprises a pressing surface 102, a first connecting arm 104, and a handle 106. The screw clamp subassembly 200 comprises a first screw 202, a second screw 204, a first clamp frame 206, a second clamp frame 208, a clamping plate 210, a second connecting arm 212, and a pin 214.

The pressing surface 102 of the preferred embodiment is circular in shape but need not be limited accordingly. The pressing surface 102 is preferably composed of cast iron. However, the pressing surface 102 may be composed of a variety of suitable materials. For example, the pressing surface 102 may and can be composed of a metal or metal alloy selected from the group consisting of carbon core stainless steel, aluminum core stainless steel, solid stainless steel with braised heat conducting base, carbon steel, copper aluminum clad stainless steel, and cast iron. The pressing surface 102 may additionally comprise a non-stick coating, such as polytetrafluoroethylene (PTFE) to reduce friction and prevent food particles from adhering to the pressing surface 102, facilitating the process of cleaning the pressing surface 102. The pressing surface 102 is applied directly to a food item such that a user may uniformly apply heat to the food item, allowing for a faster cooking time.

The pressing subassembly 100 comprises a first connecting arm 104 that is perpendicularly connected to both the pressing surface 102 and the handle 106. The first connecting arm 104 is illustratively composed of cast iron but may be fabricated from a metal or metal alloy suitable for cooking purposes. As illustrated in the preferred embodiment, the first connecting arm 104 is a cast iron bar that forms a 90-degree angle at its center. The first connecting arm 104 may be composed of a single mold or, alternatively, may be formed of two cast iron bars welded at a 90-degree angle. Likewise, the first connecting arm 104 and pressing surface 102 may be constructed as either separate components or as a single continuous molded unit, depending on the desired manufacturing process and design specifications.

In the preferred embodiment, the first connecting arm 104 is securely welded to the pressing surface 102. However, the pressing surface 102 may also be connected to the first connecting arm 104 according to a number of alternatives, such as through the use of bolts, screws, or adhesives.

It should be noted that the manner in which the connecting arm 104 is connected to the pressing surface 102 is not limited according to any particular shape or structure. For example, the first connecting arm 104 may be pivotally attached to the pressing surface 102 using a swivel mechanism (not depicted) that allows for rotational movement, providing the ability for the first connecting arm 104 to swivel during operation. This swivel connection can be achieved by incorporating a rotating pin or axle that passes through a specially designed swivel joint, which is positioned at the point where the first connecting arm 104 meets the pressing surface 102. The swivel joint may consist of a bushing or bearing system, which reduces friction and ensures smooth, controlled movement as the arm pivots. The pin or axle is securely fastened to both the pressing surface 102 and the first connecting arm 104, allowing the first connecting arm 104 to rotate around the axis of the joint, while maintaining a firm connection that prevents unintended detachment. This swivel mechanism allows the user to adjust the position of the handle 106.

The handle 106 is cylindrical in shape and composed of a heat-resistant material, such as plastic, metal, or a heat-resistant silicone composite. The handle 106 need not be limited to the cylindrical shape illustrated in the preferred embodiment, and may further comprise ergonomic grooves or contours, enhancing grip comfort and providing a user with greater control over the pressing subassembly 100 during use. The handle 106 is illustratively connected to the first connecting arm 104 via a welded stud. However, the handle 106 may also be welded directly to the first connecting arm 104. In another example, the handle 106 may be attached to the first connecting arm 104 through a reinforced mechanical joint via screws or rivets. The handle 106 allows a user to safely lift the pressing subassembly 100 out of the way of the stovetop 92, whereas the first connecting arm 104 extends the handle 106 away from the stovetop 92 and the pressing surface 102, thus minimizing the risk of injury during use.

The cooking press assembly 90 further comprises a screw clamp subassembly 200. The screw clamp subassembly comprises a first screw 202, a second screw 204, a first clamp frame 206, a second clamp frame 208, a clamping plate 210, a second connecting arm 212, and a pin 214.

The first screw 202 passes through the first clamp frame 206 and tightens against a surface of the blacktop stove. Likewise, the second screw 204 passes through the second clamp frame 208. The first screw 202 and second screw 204 can be loosed or tightened to accommodate stovetops or surfaces of varying shapes and dimensions. The clamping pressure is adjustable by turning the screws 202 204, allowing the user to apply varying levels of force to securely fasten the cooking press assembly 90 to a stovetop 92, or any other desired surface. As illustrated, the first screw 202 and second screw 204 are swivel head screws but need not be limited to this shape or structure. For example, hex-head screws, slotted screws, ball-ended screws, and Phillips head screws are alternatives that are envisioned. The first screw 202 and second screw 204 press directly against the stovetop 92, securely attaching the cooking press assembly 90 thereto.

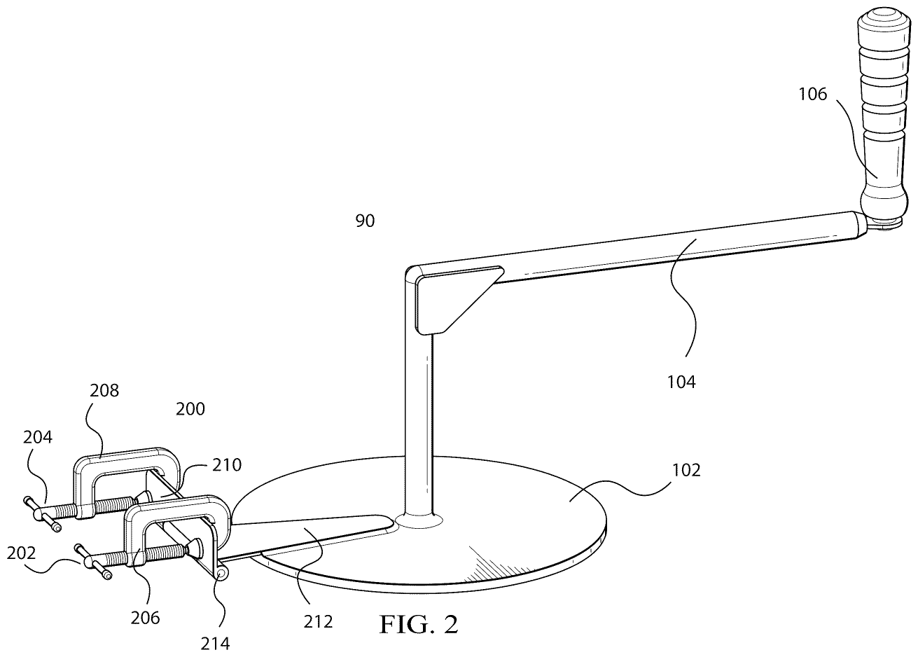

FIG. 2 depicts the cooking press assembly 90, wherein the cooking press assembly 90 is not attached to a stovetop. As depicted in FIG. 2, the first screw 202 and second screw 204 are flared at one end, providing a wider surface area for each to attach to a surface of the stovetop 92.

The first screw 202 and the second screw 204 are held firmly in place by a first clamp frame 206 and a second clamp frame 208, respectively. The clamp frames 206 208 are illustratively composed of cast iron but may be manufactured from an alternative heat-resistant metal or metal alloy. The first clamp frame 206 and second clamp frame 208 are connected to the clamping plate 210. In the preferred embodiment, the clamping plate 210 is composed of cast iron, but may be made of any metal or other material suitable for cooking applications. The clamping plate 210 evenly distributes pressure across the surface of the stove to which the cooking press assembly 90 is attached. The clamping plate 210 may feature a smooth or textured surface. In the preferred embodiment, the first clamp frame 206 and second clamp frame 208 are welded to the clamping plate 210. However, the first clamp frame 206, second clamp frame 208, and clamping plate 210 may be formed of one continuous mold to enhance the structural integrity of the screw clamp subassembly 200.

Referring back to FIG. 1, the clamping plate 210 further comprises knuckles 211 to accommodate a pin 214, such that a second connecting arm 212 can rotate about the pin 214, forming a hinge.

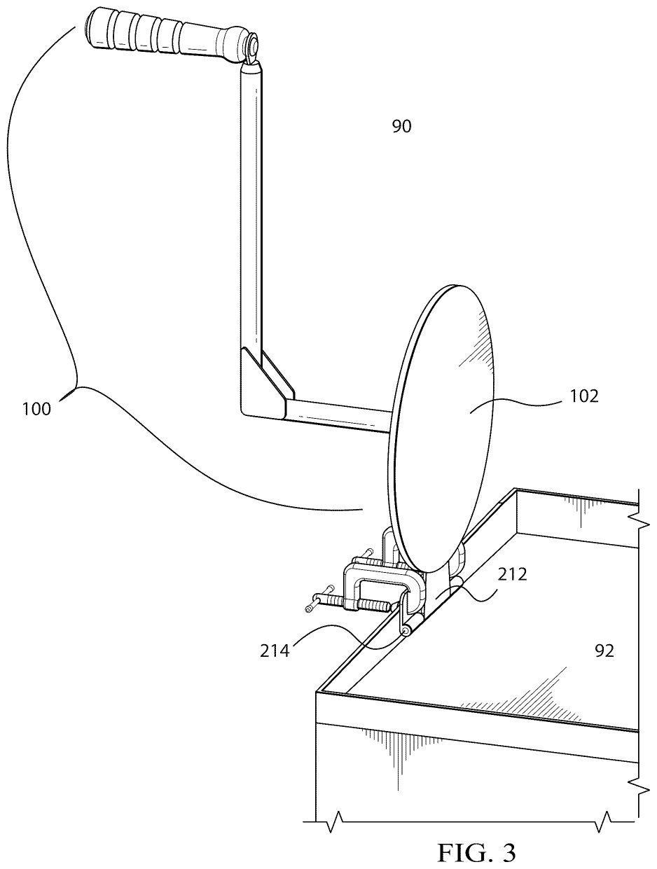

FIG. 3 is a perspective view of the cooking press assembly 90 wherein the pressing subassembly 100 is in the upright position. As depicted in FIG. 3, the pressing subassembly 100 may be lifted into an upright position by rotating the second connecting arm 212 about the pin 214, such that the cooking press assembly 90 does not obstruct the surface of the stovetop 92.

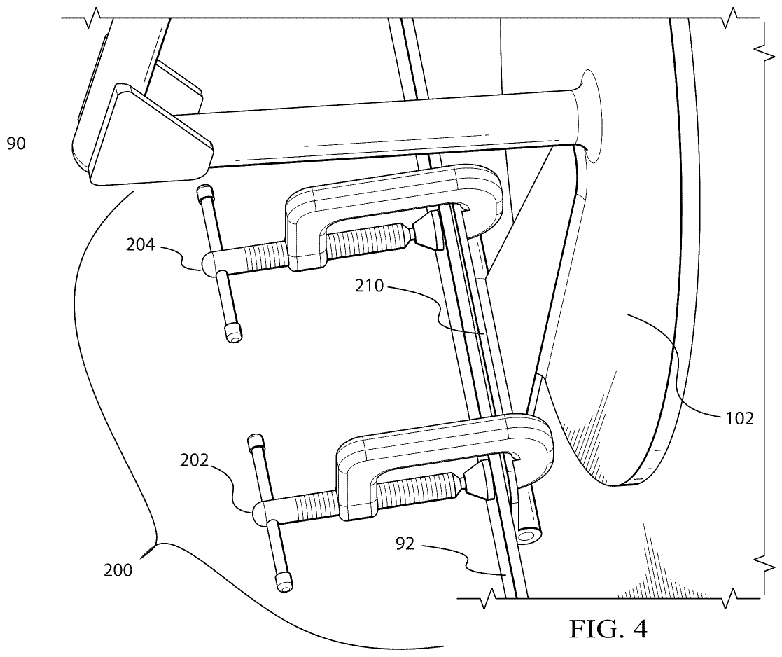

FIG. 4 provides a magnified view of the screw clamp subassembly 200, wherein the pressing surface 102 is in the upright position. The first screw 202 and second screw 204 are tightened directly against a surface of the stovetop 92. The clamping plate 210 presses against the opposite side of the surface of the stovetop 92, securely fastening the cooking press assembly 90 thereto.

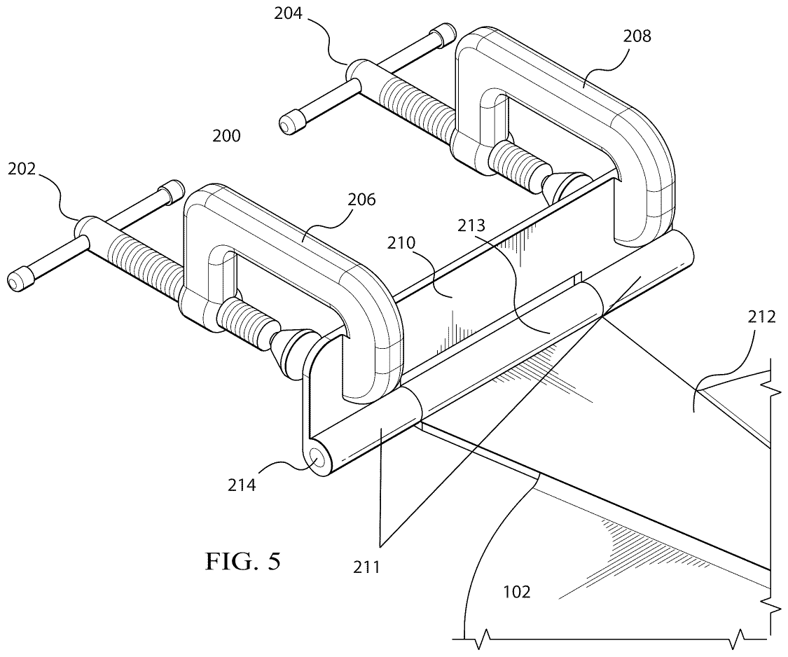

FIG. 5 depicts a magnified view of the screw clamp subassembly 200, wherein the pressing surface 102 is in the down position. Notably, the second connecting arm 212 also comprises a knuckle 213, such that the pin 214 can be threaded through both the clamping plate 210 and the second connecting arm 212, forming a hinge. The knuckles 211 213 are formed through a precision manufacturing process to accommodate a pin 214 for a hinge, ensuring a secure and durable pivoting connection. Initially, the clamping plate 210 and second connecting arm 212 are subjected to punching or stamping to create a series of aligned, raised projections or loops, referred to as knuckles 211 213, along the edge where the hinge is to be installed. The knuckles 211 213 are then bent or folded at a specific angle, typically at 90 degrees to the surface of the metal, to form a cylindrical or semi-cylindrical shape that will house the pin 214. To ensure proper alignment and smooth pivoting motion, the inner diameter of each knuckle 211 213 is precisely sized to match the diameter of the pin 214. In some cases, the knuckles 211 213 may undergo sintering or heat treatment to increase their strength and wear resistance, ensuring a long-lasting and functional hinge mechanism. The knuckles 211 213 may also be reinforced or thickened in high-stress areas to further enhance their durability and ability to withstand the forces applied during the clamping or pivoting action. Once formed, the knuckles are ready to receive the pin 214, allowing for smooth, controlled rotation of the hinged component.

In the preferred embodiment, the second connecting arm 212, like the first connecting arm 104, is composed of cast iron. The second connecting arm 212 is illustratively oblong but need not be limited to a particular shape. The second arm 104 may be composed of a variety of metals or metal allows suitable for cooking applications. The second connecting arm 212 is welded to the pressing surface 102. However, the second connecting arm and pressing surface 102 may also be composed of a single mold, thereby negating the need for welding. The second connecting arm 212 connects the pressing subassembly 100 to the screw clamp subassembly 200.

Referring again to FIG. 1, the present invention solves the need for a removable cooking press assembly 90 by providing a screw clamp subassembly 200 that attaches to a stovetop 92 by tightening a first screw 202, a second screw 204, and clamping plate 210 against a surface of the stovetop 92. A user may then rotate the pressing subassembly 100, which is connected to the second connecting arm 212, about the pin 214. A user may then rotate the pressing surface 102 onto the stovetop 92 when desired, thereby reducing cooking times by providing a convenient cooking press solution.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features.

Having described and illustrated the principles of the invention in a preferred embodiment thereof, it should be apparent that the invention may be modified in arrangement and detail without departing from such principles. Claim is made to all modifications and variation coming within the spirit and scope of the following claims.

What is claimed is:

1. A cooking press assembly, comprising:
a pressing subassembly, the pressing subassembly comprising:
a pressing surface,
a first connecting arm, and
a handle;
and a screw clamp subassembly, the screw clamp subassembly comprising:
a first screw,
a first clamp frame,
a second screw,
a second clamp frame,
a clamping plate,
a second connecting arm, and
a pin.

2. The cooking press assembly of claim 1, wherein the pressing surface is made of cast iron.

3. The cooking press assembly of claim 1, wherein the pressing surface further comprises a non-stick coating.

4. The cooking press assembly of claim 1, wherein the first connecting arm is rotatably connected to the pressing surface.

5. The cooking press assembly of claim 1, wherein the first connecting arm is welded to the pressing surface.

6. The cooking press assembly of claim 1, wherein the handle is composed of a heat-resistant material.

7. The cooking press assembly of claim 1, wherein the handle further comprises ergonomic grooves.

8. The cooking press assembly of claim 1, wherein the pressing surface and the second connecting arm form one continuous member.

9. The cooking press assembly of claim 1, wherein the first screw is a swivel head screw.

10. The cooking press assembly of claim 1, wherein the second screw is a swivel head screw.

11. The cooking press assembly of claim 1, wherein the clamping plate further comprises knuckles for receiving the pin.

12. The cooking press assembly of claim 1, wherein the second connecting arm further comprises a knuckle for receiving the pin.

13. The cooking press assembly of claim 1, wherein the pressing surface is made of a metal alloy.

14. The cooking press assembly of claim 1, further comprising a stovetop.
